(19) United States
(12) Patent Application Publication
(10) Pub. No.: US 2023/0247511 A1
(43) Pub. Date: Aug. 3, 2023

(54) CELL SELECTION TECHNIQUES FOR DUAL-CONNECTIVITY OPERATION

(71) Applicant: QUALCOMM INCORPORATED, San Diego, CA (US)

(72) Inventor: Akash KUMAR, Hyderabad (IN)

(21) Appl. No.: 18/003,606

(22) PCT Filed: Jul. 27, 2021
(86) PCT No.: PCT/US2021/070971

§ 371 Date: Dec. 28, 2022

(30) Foreign Application Priority Data
Aug. 24, 2020 (IN) 202041036347

(51) Int. Cl. H04W 36/30; H04W 52/36

(52) U.S. Cl. CPC H04W 36/30; H04W 52/367; H04W 88/06

(57) ABSTRACT

Methods, systems, and devices for wireless communications are described. A wireless device that supports concurrent communications using multiple radio access technologies may receive multiple indications of primary upper power limits for transmitting over multiple primary cells. The wireless device may select a primary cell having a primary upper power limit that is below a threshold. A secondary upper power limit for performing uplink transmission over a secondary cell may be based on the primary upper power limit for the selected primary cell. The wireless device may perform uplink transmissions over the primary cell and the secondary cell in accordance with the primary and secondary upper power limits.

### CROSS REFERENCES

The present Application is a 371 national stage filing of International PCT Application No. PCT/US2021/070971 by KUMAR entitled “CELL SELECTION TECHNIQUES FOR DUAL-CONNECTIVITY OPERATION,” filed Jul. 27, 2021; and claims priority to Indian Patent Application No. 202041036347 by KUMAR entitled “CELL SELECTION TECHNIQUES FOR DUAL-CONNECTIVITY OPERATION,” filed Aug. 24, 2020, each of which is assigned to the assignee hereof, and each of which is expressly incorporated by reference in its entirety herein.

### FIELD OF TECHNOLOGY

The following relates to wireless communications, including cell selection techniques for dual-connectivity operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A wireless communications system may support concurrent communications between a base station and UE that use different radio access technologies (e.g., LTE and 5G). A UE that is capable of performing concurrent communications using different radio access technologies may be referred to as a dual-connectivity UE.

### SUMMARY

The described techniques relate to improved methods, systems, devices, and apparatuses that support cell selection techniques for dual-connectivity operation. A wireless device that is configured to support concurrent communications using multiple radio access technologies may receive multiple indications of upper power limits for transmitting over multiple primary cells—e.g., the wireless device may receive a first indication that indicates a first upper power limit for a first primary cell, a second indication that indicates a second (e.g., different) upper power limit for a second primary cell, and so on. The wireless device may then select a primary cell having an upper power limit that is below a threshold (e.g., the first primary cell). In some examples, the wireless device selects the primary cell based on a set of selection criteria being satisfied by the primary cell. The wireless device may perform uplink transmissions over the primary cell in accordance with the upper power limit.

A method for wireless communication is described. The method may include receiving, at a UE that supports concurrent communications using a first radio access technology and a second radio access technology, a set of indications indicating upper power limits for uplink transmissions over a set of cells that support the first radio access technology, selecting a cell of the set of cells based on a selection criteria being satisfied by the cell and an upper power limit for the cell being less than or equal to a threshold, and transmitting an uplink transmission over the cell in accordance with the upper power limit for the cell.

An apparatus for wireless communication is described. The apparatus may include a processor, memory in electronic communication with the processor, and instructions stored in the memory. The instructions may be executable by the processor to cause the apparatus to receive, at a UE that supports concurrent communications using a first radio access technology and a second radio access technology, a set of indications indicating upper power limits for uplink transmissions over a set of cells that support the first radio access technology, select a cell of the set of cells based on a selection criteria being satisfied by the cell and an upper power limit for the cell being less than or equal to a threshold, and transmit an uplink transmission over the cell in accordance with the upper power limit for the cell.

Another apparatus for wireless communication is described. The apparatus may include means for receiving, at a UE that supports concurrent communications using a first radio access technology and a second radio access technology, a set of indications indicating upper power limits for uplink transmissions over a set of cells that support the first radio access technology, means for selecting a cell of the set of cells based on a selection criteria being satisfied by the cell and an upper power limit for the cell being less than or equal to a threshold, and means for transmitting an uplink transmission over the cell in accordance with the upper power limit for the cell.

A non-transitory computer-readable medium storing code for wireless communication is described. The code may include instructions executable by a processor to receive, at a UE that supports concurrent communications using a first radio access technology and a second radio access technology, a set of indications indicating upper power limits for uplink transmissions over a set of cells that support the first radio access technology, select a cell of the set of cells based on a selection criteria being satisfied by the cell and an upper power limit for the cell being less than or equal to a threshold, and transmit an uplink transmission over the cell in accordance with the upper power limit for the cell.

Some examples of the method, apparatuses, and non-transitory computer-readable medium described herein may further include operations, features, means, or instructions for estimating an amount of power to support uplink transmissions over a second cell that supports the second radio access technology and determining the threshold based on the amount of power.

Some examples of the method, apparatuses, and non-transitory computer-readable medium described herein may further include operations, features, means, or instructions for transmitting, concurrently with the uplink transmission over the cell, a second uplink transmission over the second cell in accordance with the second upper power limit.

In some examples of the method, apparatuses, and non-transitory computer-readable medium described herein, estimating a first amount of power based on identifying a first amount of uplink information for transmission over the second cell may include operations, features, means, or instructions for estimating a first amount of power based on identifying a first amount of uplink information for transmission over the second cell and estimating a second amount of power based on identifying a second amount of uplink information for transmission over the second cell, where the second amount of power may be greater than the first amount of power based on the second amount of uplink information being greater than the first amount of uplink information.

In some examples of the method, apparatuses, and non-transitory computer-readable medium described herein, determining a first threshold based on the first amount o may include operations, features, means, or instructions for determining a first threshold based on the first amount of power and determining a second threshold based on the second amount of power, the second threshold being lower than the first threshold.

In some examples of the method, apparatuses, and non-transitory computer-readable medium described herein, selecting, prior to selecting the cell of the set of cells, a third cell of the set of cells based on the selection criteria being satisfied, where a third upper power limit for the third cell may be greater than the upper power limit for the cell, determining, based on the third upper power limit for the third cell, a second upper power limit for uplink transmissions over the second cell that supports the second radio access technology, and selecting, during a reselection procedure, the cell of the set of cells having the upper power limit that may be less than the third upper power limit based on the estimated amount of power for supporting uplink transmissions over the second cell exceeding the second upper power limit.

Some examples of the method, apparatuses, and non-transitory computer-readable medium described herein may further include operations, features, means, or instructions for determining, based on the upper power limit for the cell, a fourth upper power limit for uplink transmissions over the second cell that supports the second radio access technology, where the estimated amount of power for supporting uplink transmissions over the second cell may be less than or equal to the fourth upper power limit.

In some examples of the method, apparatuses, and non-transitory computer-readable medium described herein, a first signal quality for the cell may be less than a second signal quality for the second cell.

In some examples of the method, apparatuses, and non-transitory computer-readable medium described herein, the cell may be included in a primary cell group and the second cell may be included in a secondary cell group.

Some examples of the method, apparatuses, and non-transitory computer-readable medium described herein may further include operations, features, means, or instructions for determining a second amount of power available for uplink transmissions over the second cell based at least in part on the upper power limit for the cell; and modifying, based at least in part on the amount of power exceeding the second amount of power by a third amount, a procedure for selecting cells to be based at least in part on the threshold.

Some examples of the method, apparatuses, and non-transitory computer-readable medium described herein may further include operations, features, means, or instructions for receiving, from a base station, an indication of the threshold based on supporting concurrent communications using the first radio access technology and the second radio access technology.

In some examples of the method, apparatuses, and non-transitory computer-readable medium described herein, selecting the cell based on determining that the upper power limit for the cell may be the lowest of a set of upper power limits for the plurality of cells may include operations, features, means, or instructions for selecting the cell based on determining that the upper power limit for the cell may be the lowest of a set of upper power limits for the set of cells.

Some examples of the method, apparatuses, and non-transitory computer-readable medium described herein may further include operations, features, means, or instructions for storing an indication of a subset of the set of cells having upper power limits that may be below the threshold, the subset of the set of cells including the cell and identifying the cell may be included in the subset of the set of cells based on the indication, where the cell may be selected based on the identifying.

Some examples of the method, apparatuses, and non-transitory computer-readable medium described herein may further include operations, features, means, or instructions for activating a second cell that supports the second radio access technology and modifying a procedure for selecting cells to be based on the threshold.

Some examples of the method, apparatuses, and non-transitory computer-readable medium described herein may further include operations, features, means, or instructions for receiving a set of system information messages including the set of indications, where the set of system information messages include one or more of a SIB 1 message, a SIB 3 message, a SIB 5 message, or a SIB 6 messages.

In some examples of the method, apparatuses, and non-transitory computer-readable medium described herein, a second upper power limit for uplink transmissions over a second set of cells that support the second radio access technology may be based on the upper power limit for the cell.

In some examples of the method, apparatuses, and non-transitory computer-readable medium described herein, the second upper power limit decreases when the upper power limit for uplink transmissions over the set of cells that support the first radio access technology increases, and where the second upper power limit increases when the upper power limit for uplink transmissions over the set of cells decreases.

In some examples of the method, apparatuses, and non-transitory computer-readable medium described herein, the UE is operating in an idle mode and cells that supports the second radio access technology are absent for selection by the UE.

### BRIEF DESCRIPTION OF THE DRAWINGS

FIG. 1 illustrates an example of a system for wireless communications that supports cell selection techniques for dual-connectivity operation in accordance with aspects of the present disclosure.

FIG. 2 illustrates an example of a wireless communications subsystem that supports cell selection techniques for dual-connectivity operation in accordance with aspects of the present disclosure.

FIG. 3 illustrates an example of a process flow that supports cell selection techniques for dual-connectivity operation in accordance with aspects of the present disclosure.

FIGS. 4 and 5 show block diagrams of devices that support cell selection techniques for dual-connectivity operation in accordance with aspects of the present disclosure.

FIG. 6 shows a block diagram of a communication manager that supports cell selection techniques for dual-connectivity operation in accordance with aspects of the present disclosure.

FIG. 7 shows a diagram of a system including a device that supports cell selection techniques for dual-connectivity operation in accordance with aspects of the present disclosure.

FIG. 8 shows a flowchart illustrating methods that support cell selection techniques for dual-connectivity operation in accordance with aspects of the present disclosure.

### DETAILED DESCRIPTION

A wireless device may be configured to communicate data over a first cell in accordance with a first radio access technology and a secondary cell in accordance with a second radio access technology. In some examples, the first cell may be included in a first cell group (which may be referred to as a “master cell group” or a “primary cell group”) and may be referred to as a “master cell” or a “primary cell.” And the secondary cell may be included in a second cell group (which may be referred to as a “secondary cell group”) and may be referred to as a “secondary cell.” In some examples, a wireless device may be configured to prioritize uplink transmissions using the primary cell over uplink transmissions using the secondary cell—e.g., if the primary cell is scheduled to convey critical control information.

In some examples, a wireless device may share available transmission power between concurrent uplink transmissions performed over the primary cell and secondary cell. In such cases, as a maximum transmission power available for uplink transmissions over the master cell increases, the maximum transmission power available for uplink transmissions over the secondary cell decreases—e.g., non-linearly; a 1 dB increase for the master cell may result in a 7 dB decrease for the secondary cell. When uplink transmissions over the primary cell are prioritized, the wireless device may make an amount of transmission power (e.g., 23 dB) available to uplink transmissions over the primary cell that results in an insufficient amount of transmission power (e.g., 8 dB) being available for uplink transmissions over the secondary cell.

In some examples, a wireless device (e.g., a UE) may increase a maximum transmission power for transmissions over a primary cell (or primary cell group) using a first radio access technology such that a reliability of transmissions over a secondary cell (or secondary cell group) using a second radio access technology is degraded—e.g., because a maximum transmission power available for transmissions over the secondary cell may be significantly reduced. Accordingly, to increase a reliability of transmissions over the secondary cell group, a base station may reduce a modulation and coding scheme and number of resource blocks until a block error rate falls below a threshold value (e.g., <8%), significantly reducing throughput over the secondary cell.

To prevent the maximum transmission power available for transmissions over a secondary cell that uses a different radio access technology from being significantly reduced, a wireless device (e.g., a UE) may be configured to select primary cells (when available) that indicate a maximum transmission power for uplink transmissions over the primary cell that is below a threshold. In some examples, a wireless device that is configured to support concurrent communications using multiple radio access technologies receives multiple indications of upper power limits for transmitting over multiple primary cells—e.g., the wireless device may receive a first indication that indicates a first upper power limit for a first primary cell, a second indication that indicates a second upper power limit (e.g., a different upper power limit) for a second primary cell, and so on. The wireless device may then select a primary cell having an upper power limit that is below a threshold (e.g., the first primary cell). In some examples, the wireless device selects the primary cell based on a set of selection criteria being satisfied by the primary cell. The wireless device may perform uplink transmissions over the primary cell in accordance with the upper power limit.

By selecting a primary cell having an upper power limit that is below the threshold, the wireless device may ensure that a minimum amount of power will be available for transmissions over a secondary cell. For example, if the primary cell limits uplink transmissions to a first amount of power (e.g., <20 dBm), then a second amount of power (e.g., >20 dBm) may be available for uplink transmission over the secondary cell. In some examples, the threshold is determined based on an estimate of an amount of power that will be used for uplink transmissions over the secondary cell—e.g., if it is estimated that subsequent uplink transmissions will use <21 dBm, then a threshold of 18 dBm may be set for uplink transmissions over primary cells and a primary cell that indicates an upper power limit of <18 dBm may be selected.

Aspects of the disclosure are initially described in the context of wireless communications systems. Aspects of the disclosure are further illustrated by and described with reference to a process flow that illustrates operations associated with performing cell selection techniques for dual-connectivity operation. Aspects of the disclosure are further illustrated by and described with reference to apparatus diagrams, system diagrams, and flowcharts that relate to cell selection techniques for dual-connectivity operation.

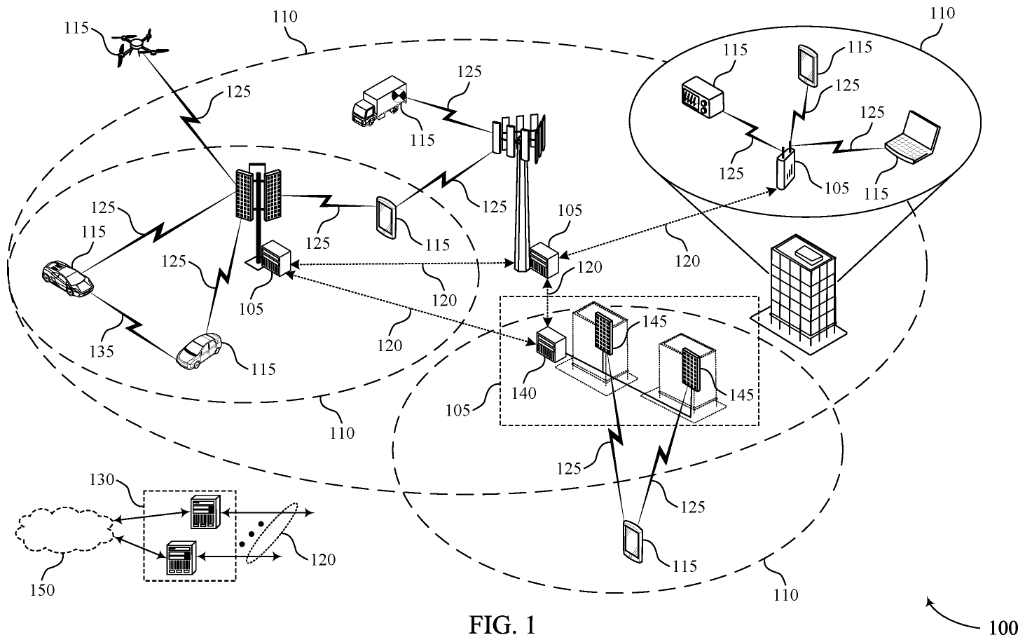

FIG. 1 illustrates an example of a wireless communications system 100 that supports cell selection techniques for dual-connectivity operation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may be within a coverage area of multiple cells. In such cases, the UE 115 may perform a procedure for selecting a cell of the multiple cells for subsequent communications—this procedure may be referred to as cell selection. The procedure for selecting the cell may include considering a set of cell selection criteria—e.g., signal strength of the cell, signal quality of the cell, network identification, service type, etc. In some examples, a UE 115 may avoid registering to cells having signal strengths and/or signal quality that is below a threshold. When the UE 115 identifies multiple cells having a signal strength and signal quality that exceeds the threshold, the UE 115 may consider additional criteria to select one of the cells—e.g., absolute measured cell power, priority, and the like.

In some examples, information received in system information messages (e.g., system information block (SIB) 1, SIB 2, etc.) transmitted over the multiple cells may be used to assist the UE 115 in selecting a cell. For example, a system information message may be used to convey a minimum signal strength that should be measured by the UE 115 before registering to the cell and a minimum signal quality that should be measured by the UE 115 before registering to the cell. The system information message may also be used to convey a maximum uplink transmission power for which the UE 115 may transmit uplink information over the cell—the UE 115 may use the maximum power parameter to refine a signal strength measurement taken by the UE 115.

After selecting the cell, the UE 115 may register to the cell and enter an idle mode. While in the idle mode, the UE 115 may continue to measure signal strength and signal quality for the registered cell. If the measured signal strength and/or signal quality falls below a threshold the UE 115 may perform a procedure for selecting a different cell using the criteria described above—this procedure may be referred to as cell reselection. In some examples, after registering to the cell, the UE 115 may enter a connected mode—e.g., to exchange data over the cell. After entering the connected mode, the UE 115 may return to the idle mode. While transitioning from the connected mode to the idle mode, the UE 115 may again perform the cell selection procedure and may register to the same or a different cell.

A wireless communications system 100 may support the communication of information within the wireless communications system 100 using one or more multiple radio access technologies (e.g., 3G, LTE, 4G, 5G, etc.). In some examples, a UE 115 may support communicating with a base station 105 in accordance with multiple radio access technologies e.g., the UE 115 may perform one communication using a first radio access technology and a first cell and another, concurrent communication using a second radio access technology and a second cell. In some examples, a UE 115 may use a first cell to perform communications with a base station 105 in accordance with an LTE technology and a second cell to perform communications with the base station 105 (or another coupled base station 105) in accordance with a new radio technology (e.g., 5G). In such examples, UE 115 may be referred to as operating in an E-UTRA/New Radio dual connectivity (ENDC) mode, and the first cell may be included in a master cell group (or primary cell group) while the second cell may be included in a secondary cell group. In some examples, the first cell may be referred to as a primary cell and the second cell may be referred to as a secondary cell.

A UE 115 that operates in an ENDC mode may transmit uplink information (e.g., control and/or data) to a serving base station 105 using uplink resources allocated to the UE 115 by the base station 105. In some examples, the serving base station 105 allocates a first set of resources for reporting the uplink information over a primary cell (or primary cell group) that is configured in accordance with a first radio access technology (e.g., LTE) and a second set of resources for reporting uplink information over a secondary cell (or secondary cell group) that is configured in accordance with a second radio access technology (e.g., 5G).

A UE 115 that transmits over both the primary cell and the secondary cell may be constrained by a combined maximum power limit. That is, in some examples, a UE 115 may be capable of transmitting with a combined maximum transmission power of around 23 dBm. The UE 115 may share the combined maximum transmission power between uplink transmissions performed over the primary cell (or a primary cell group) and uplink transmissions concurrently performed over the secondary cell (or a secondary cell group). For example, the UE 115 may perform a first uplink transmission over the primary cell (or primary cell group) with a maximum transmission power of 20 dBm and may perform a second uplink transmission over the secondary cell (or secondary cell group) with a maximum transmission power of 20 dBm (which may correspond to a combined maximum transmission power of around 23 dBm). In another example, the UE 115 may perform a first uplink transmission over the primary cell (or primary cell group) with a maximum transmission power of 23 dBm and may perform a second uplink transmission over the secondary cell (or secondary cell group) with a maximum transmission power of 8 dBm (which may correspond to a combined maximum transmission power of around 23 dBm). Table 1 illustrates an example indicating how available transmission power can be shared between two cells (or cell groups) using LTE and NR access technology.

| Output Power (dBm) | | | Tolerance (LTE | Tolerance (NR |
|---|---|---|---|---|
| LTE | NR | Total | Output Power) | Output Power) |
| 23 | 8 | 23.1 | +2.7 dB/−1.7 dB | ±2.7 dB |
| 22 | 15 | 22.8 | ±.5 dB | ±2.7 dB |
| 21 | 18 | 22.8 | ±.5 dB | ±2.7 dB |
| 20 | 20 | 23.0 | ±.5 dB | ±2.7 dB |
| 18 | 21 | 22.8 | ±.5 dB | +2.7 dB/−1.7 dB |
| 15 | 22 | 22.8 | ±.5 dB | +2.7 dB/−1.7 dB |
| 8 | 23 | 23.1 | ±.5 dB | +2.7 dB/−1.7 dB |

As described herein, a base station 105 may indicate in control signaling (e.g., in a SIB transmission) a maximum transmission power that a UE 115 is permitted to use for transmissions over a cell (or cell group). For example, a base station 105 may indicate that a UE 115 is prohibited from transmitting over an LTE cell (or LTE cell group) using a transmission power that exceeds 20 dBm. In such examples, a maximum transmission power available for transmitting over a NR cell (or NR cell group) may be greater than or equal to 20 dBm while the UE 115 is registered on the LTE cell.

In some examples, a UE 115 may be configured to transmit a majority of uplink information over a secondary cell (or secondary cell group). The UE 115 may also be configured to transmit uplink control information (e.g., channel quality information (CQI), hybrid automatic repeat request (HARQ) feedback, etc.) that is used to maintain a reliable connection with the serving base station 105 over a primary cell (or primary cell group). In some examples, uplink transmissions over the primary cell may be prioritized over uplink transmissions over the secondary cell at the UE 115. For example, the UE 115 may be configured to increase an uplink transmission power of uplink transmissions over the primary cell at the expense of uplink transmissions over the secondary cell—e.g., the UE 115 may reduce a power for uplink transmissions over the secondary cell if additional power is needed for an uplink transmission over the primary cell.

In some examples, a wireless device (e.g., a UE) may increase a maximum transmission power for transmissions over a primary cell (or primary cell group) using a first radio access technology such that a reliability of transmissions over a secondary cell (or secondary cell group) using a second radio access technology is degraded—e.g., because a maximum transmission power available for transmissions over the secondary cell may be significantly reduced. Accordingly, to increase a reliability of transmissions over the secondary cell group, a base station 105 may reduce a modulation and coding scheme and number of resource blocks until a block error rate falls below a threshold value (e.g., <8%), significantly reducing throughput over the secondary cell. Such behavior may occur when the wireless device is positioned on an edge of the primary cell. In such cases, the wireless device may use a high transmission power to transmit over a small number of resources allocated in the primary cell, and thus, may be prevented from reliably transmitting a larger amount of uplink data over a larger number of resources allocated in the secondary cell.

To prevent the maximum transmission power available for transmissions over a secondary cell that uses a different radio access technology from being significantly reduced, a wireless device (e.g., a UE) may be configured to select primary cells (when available) that indicate a maximum transmission power for uplink transmissions over the primary cell that is below a threshold. In some examples, a wireless device that is configured to support concurrent communications using multiple radio access technologies receives multiple indications of upper power limits for transmitting over multiple primary cells—e.g., the wireless device may receive a first indication that indicates a first upper power limit for a first primary cell, a second indication that indicates a second upper power limit (e.g., a different upper power limit) for a second primary cell, and so on. The wireless device may then select a primary cell having an upper power limit that is below a threshold (e.g., the first primary cell). In some examples, the wireless device selects the primary cell based on a set of selection criteria being satisfied by primary the cell. The wireless device may perform uplink transmissions over the primary cell in accordance with the upper power limit.

By selecting a primary cell having an upper power limit that is below the threshold, the wireless device may ensure that a minimum amount of power will be available for transmissions over a secondary cell. For example, if the primary cell limits uplink transmissions to a first amount of power (e.g., <20 dBm), then a second amount of power (e.g., >20 dBm) may be available for uplink transmission over the secondary cell. In some examples, the threshold is determined based on an estimate of an amount of power that will be used for uplink transmissions over the secondary cell—e.g., if it is estimated that subsequent uplink transmissions will use <21 dBm, then a threshold of 18 dBm may be set for uplink transmissions over primary cells and a primary cell that indicates an upper power limit of <18 dBm may be selected.

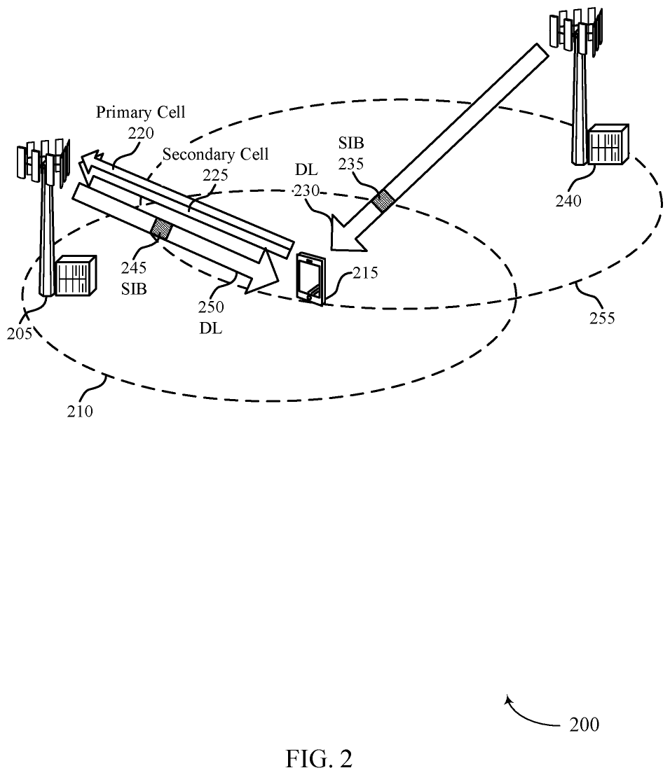

FIG. 2 illustrates an example of a wireless communications subsystem that supports cell selection techniques for dual-connectivity operation in accordance with aspects of the present disclosure.

Wireless communications subsystem 200 may include first base station 205 and second base station 240, which may be examples of a base station 105, as described with reference to FIG. 1. Wireless communications subsystem may also include UE 215, which may be an example of a UE 115, as described with reference to FIG. 1. First base station 205 as second base station 240 may communicate with UE 215 within a respective first coverage area 210 and second coverage area 255, as described with reference to FIG. 1.

UE 215 may be capable of performing dual-connectivity operations. That is, UE 215 may be capable of performing concurrent communications using different radio access technologies or different cell groups of a single radio access technology. In some examples, UE 215 may communicate over primary cell 220, which may be configured in accordance with a first radio access technology, and secondary cell 225, which may be configured in accordance with a second radio access technology.

In some examples, UE 215 may be located within a coverage area of one or both of first base station 205 and second base station 240. First base station 205 and second base station 240 may each support one or more cells and may broadcast system information for the one or more cells over first downlink 250 and second downlink 230. For example, first base station 205 and second base station 240 may broadcast one or more SIBs (e.g., first SIB 245 and second SIB 235) to UE 215.

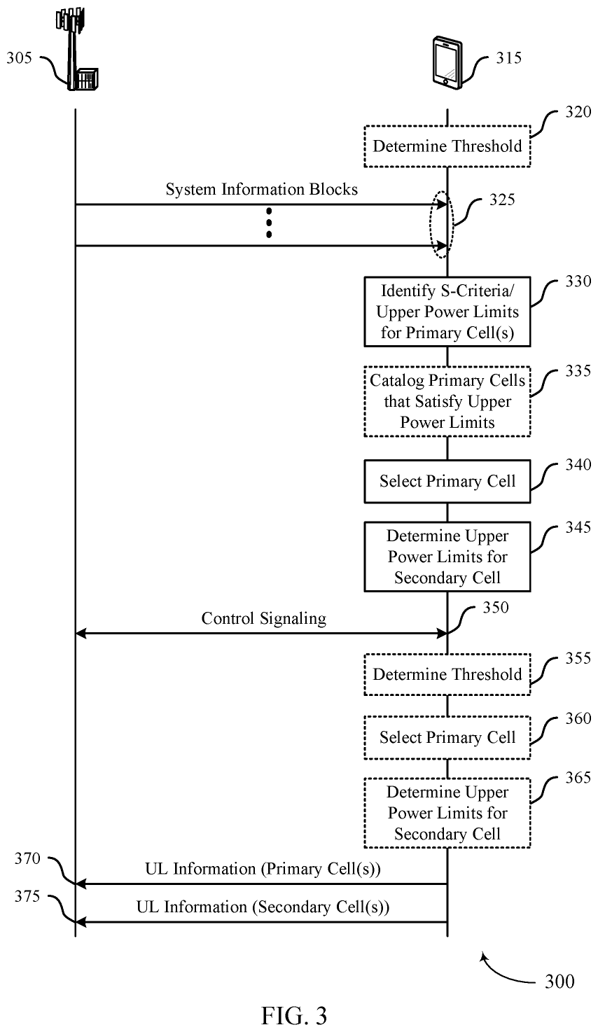

UE 215 may use the system information received for the different cells to select one of the cells for a registration procedure. In some examples, UE 215 may select primary cell 220 based on determining that selection criteria associated with signal strength and quality are met for primary cell 220 and based on determining that an upper limit for uplink transmissions in primary cell 220 is below a threshold. In some examples, UE 215 determines the threshold based on a preconfiguration, received control signaling, and/or an estimation of power to be used for transmissions over secondary cell 225. Details associated with determining a threshold and selecting a primary cell are described in more detail herein and with reference to FIG. 3.

FIG. 3 illustrates an example of a process flow that supports cell selection techniques for dual-connectivity operation in accordance with aspects of the present disclosure.

Process flow 300 may be performed by base station 305 and UE 315. Base station 305 and UE 315 may be an example of a base station and UE, respectively, as described with reference to FIGS. 1 and 2. In some examples, process flow 300 illustrates an exemplary sequence of operations performed to support selecting a primary cell that is configured in accordance with a first radio access technology and that sets an upper limit for uplink transmissions that is below a threshold when dual-connectivity operations are enabled.

One skilled in the art would understand that one or more of the operations described in process flow 300 may be performed earlier or later in the process, omitted, replaced, supplemented, or any combination thereof. Also, additional operations described herein that are not included in process flow 300 may be included.

At block 320, UE 315 may determine a threshold that sets an upper limit for a power parameter indicated by a cell that uses a first radio access technology, where the power parameter indicates an upper limit for uplink transmissions within the cell. The power parameter may be referred to as P-max. In some examples, the threshold is determined by UE 315 based on a preconfiguration. For example, the UE 315 may determine that the threshold is set at 20 dBm and may refrain from selecting a primary cell for registering having a power parameter that exceeds 20 dBm—e.g., unless there are no other cells available.

In other examples, UE 315 may estimate an amount of power that will be used by subsequent transmissions over a secondary cell that uses a different radio access technology than the first cell and determine the threshold based on the estimated amount of power. For example, if UE 315 determines that 21 dBm of power will be used for subsequent transmissions over the secondary cell, then UE 315 may set the threshold at 18 dBm. Or if UE 315 determines that 18 dBm of power will be used for subsequent transmissions over the secondary cell, then UE 315 may set the threshold at 21 dBm. In some examples, UE 315 may estimate an amount of power that will be used by subsequent transmissions over a secondary cell based on an amount of uplink information that is scheduled to be transmitted over the secondary cell.

In other examples, UE 315 may determine a threshold based on determining that UE 315 is positioned at an edge of a coverage area for a primary cell. In such cases, an amount of power used by transmissions over the primary cell may increase, causing an insufficient amount of power to be available for transmissions over the secondary cell.

In some examples, the value selected for the threshold may result in establishing a maximum amount of power being available for uplink transmissions over the secondary cell. For example, if the threshold has a value of 15 dBm, there may be up to 22 dBm of power reserved for transmissions over the secondary cell.

At arrows 325, UE 315 may receive one or more system information blocks from base station 305. UE 315 may also receive one or more system information blocks from other nearby base stations. Each system information block may correspond to a single primary cell and may carry system information for that primary cell—e.g., a minimum signal quality parameter, a minimum signal strength parameter, a maximum uplink transmission power parameter, etc. UE 315 may process and, in some cases, store the information received in the system information blocks. In some examples, UE 315 is in an idle mode (e.g., a radio resource control (RRC) idle mode).

At block 330, UE 315 may identify selection criteria and upper power limits for each primary cell associated with the system information blocks. In some examples, UE 315 may calculate a signal strength and signal quality for the cells based on the system information blocks. In some examples, UE 315 may determine upper limits for uplink transmissions within the cells based on decoding the system information blocks—e.g., based on decoding a maximum uplink power field to determine a value for the maximum uplink power field.

At block 335, UE 315 may catalog (or store) which primary cells associated with the received system information blocks have upper uplink power limits that are below the threshold. UE 315 may prioritize the catalogued primary cells for subsequent cell selection and cell reselection procedures performed by UE 315—e.g., UE 315 may select a primary cell that satisfies the selection criteria and is catalogued by UE 315 when UE 315 is in the presence of other primary cells that have not yet been processed.

At block 340, UE 315 may select a primary cell based on the identified selection criteria values and the determined upper uplink power limits. UE 315 may begin calculating selection criteria values and identifying upper uplink power limits for the primary cells associated with the received system information. In some examples, UE 315 may select the first primary cell that satisfies the selection criteria and has an upper power limit that is below the threshold. In other examples, UE 315 may select one of the primary cells after processing each of the primary cells. In such cases, UE 315 may first determine which of the primary cells satisfy the selection criteria, and next determine which of the primary cells that satisfy the selection criteria also set upper power limits for uplink transmissions that are below the threshold. After identifying the group of primary cells that satisfy both the selection criteria and upper power limit, UE 315 may select one of the primary cell. In some examples, UE 315 selects the primary cell of the group of primary cells that has the lowest upper power limit if multiple primary cells of the group of primary cells have the lowest upper power limit, UE 315 may then select the primary cell having the best signal quality. In other examples, UE 315 selects the primary cell of the group of primary cells that has the highest signal strength and/or highest signal quality. In some examples, if none of the cells have an upper uplink power limit that is below the threshold, UE 315 may select a cell from among the primary cells associated with the received system information blocks based on the selection criteria (e.g., signal quality, signal strength, priority, etc.). Once UE 315 has selected a primary cell, UE 315 may register to the primary cell. In some examples, UE 315 may select a primary cell based on upper uplink power limits when UE 315 is in an idle mode and no secondary cells are available for selection by UE 315.

At block 345, UE 315 may determine upper power limits for transmitting over a secondary cell (or secondary cell group) based on the selected primary cell. That is, UE 315 may determine an upper power limit for uplink transmissions over the secondary cell based on the upper power limit for uplink transmissions set by the selected primary cell. For examples, if the selected primary cell sets a power limit for uplink transmissions of 18 dBm, then UE 315 may determine that up to 21 dBm of power is available for transmissions over the secondary cell.

At arrow 350, base station 305 and UE 315 may exchange control information. In some examples, UE 315 may indicate to base station 305 a capability to perform dual-connectivity operations. Base station 305 may transmit configuration signaling to UE 315 that enables UE 315 to operate in a dual-connectivity mode. Base station 305 may transmit configuration signaling to UE 315 that triggers UE 315 to activate a secondary cell (or secondary cell group). In some examples, the configuration signaling includes an indication of the threshold. In some examples, the indication of the threshold overrides the threshold determined by UE 315 at block 320. In some examples, UE 315 does not determine the threshold until the indication of the threshold is received from base station 305.

At block 355, UE 315 may determine a threshold that sets an upper limit for a power parameter indicated by a cell that uses a first radio access technology—e.g., for a first or second time based on whether UE 315 determines the threshold at 320.

At block 360, UE 315 may select a primary cell based on the threshold received from base station 305. The primary cell may be different and may have a different upper uplink power limit than the primary cell selected at block 335.

At block 365, UE 315 may determine upper power limits for transmitting uplink transmissions over a secondary cell that uses a different radio access technology than the first cell based on the selected primary cell.

At arrow 370, UE 315 may transmit uplink information (e.g., uplink control information, such as CQI and HARQ feedback) to base station 305 over the selected primary cell. UE 315 may allocate an amount of power to the transmission that is in accordance with the upper uplink power limit set by the primary cell—e.g., if the upper uplink power limit is set at 18 dBm, UE 315 may transmit the uplink information over the primary cell at a power level that is less than or equal to 18 dBm. In some examples, UE 315 transmits higher priority uplink information (e.g., channel state information (CSI) and/or HARQ feedback) over the primary cell than over the secondary cell.

At arrow 375, UE 315 may transmit, concurrently with the transmission of uplink information over the selected primary cell, uplink information (e.g., uplink control information and/or uplink data) to base station 305 over a secondary cell. UE 315 may allocate an amount of power to the transmission that is in accordance with the upper uplink power limit determined from the upper uplink power limit of the primary cell—e.g., if the upper uplink power limit is set at 18 dBm, UE 315 may transmit the uplink information over the secondary cell at a power level that is less than or equal to 21 dBm. In some examples, UE 315 transmits a large amount of uplink information (e.g., control information and/or data) over the secondary cell than over the primary cell.

In some examples, UE 315 uses a cell selection or reselection technique for primary cells that considers an upper uplink power limit after dual-connectivity operation is enabled at UE 315—e.g., in control signaling exchanged at arrow 350. If dual-connectivity operation is not enabled for UE 315, UE 315 may perform cell selection and/or reselection without considering (or with less priority given to) the upper uplink power limit for the cells. Similarly, UE 315 may use a cell selection or reselection technique for primary cells that considers an upper uplink power limit after a secondary cell that supports a second radio access technology is activated, regardless of whether dual-connectivity operation is currently enabled at UE 315. If a secondary cell that supports a second radio access technology is not activated, UE 315 may perform cell selection and/or reselection without considering (or with less priority given to) the upper uplink power limit for the cells. In some examples, control signaling for activating the secondary cell is signaled at arrow 350.

In both cases, if the control signaling used to enable dual-connectivity operation and/or activating secondary cells that support a different radio access technology is received at arrow 350, UE 315 may perform the operations described at block 330 through block 345 without considering (or with less priority given to) the upper uplink power limit for the cells. In such cases, aspects of the operations related to selecting a primary cell based on upper uplink power limits described at block 330 through block 345 may be performed after the control signaling is received at arrow 350.

Similarly, UE 315 may use a cell selection or reselection technique for primary cells that considers upper uplink power limit based on determining that an estimated amount of power for subsequent transmissions over a secondary cell that support a second radio access technology exceeds an amount of power available for transmissions over the secondary cell based on the upper uplink power limit for the primary cell. For example, UE 315 may use the cell selection or reselection technique based on determining that estimated amount of power exceeds the available amount of power by a particular amount (e.g., >1 dB) or percentage value (>5%).

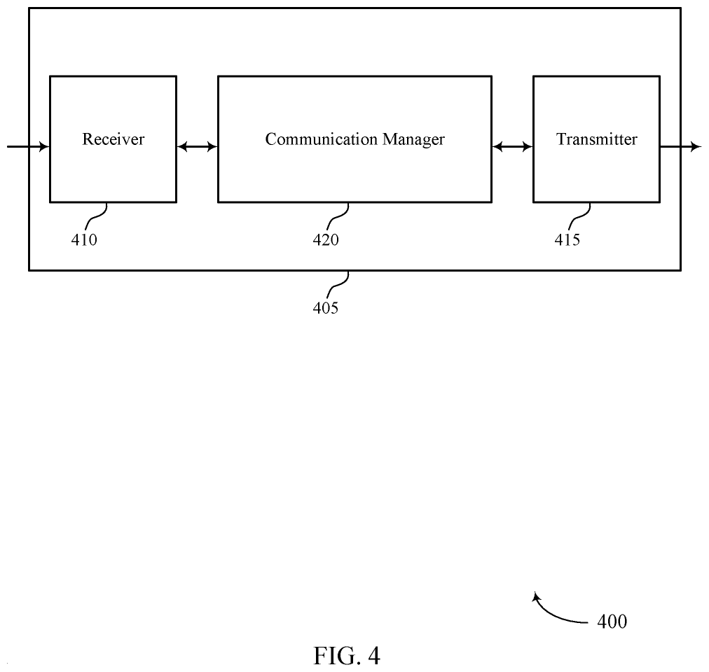

FIG. 4 shows a block diagram 400 of a device 405 that supports cell selection techniques for dual-connectivity operation in accordance with aspects of the present disclosure. The device 405 may be an example of aspects of a UE 115 as described herein. The device 405 may include a receiver 410, a transmitter 415, and a communication manager 420. The device 405 may also include a processor. Each of these components may be in communication with one another (e.g., via one or more buses).

The receiver 410 may provide a means for receiving information such as packets, user data, or control information associated with various information channels (e.g., control channels, data channels, information related to cell selection techniques for dual-connectivity operation). Information may be passed on to other components of the device 405. The receiver 410 may utilize a single antenna or a set of antennas.

The transmitter 415 may provide a means for transmitting signals generated by other components of the device 405. In some examples, the transmitter 415 may be co-located with a receiver 410 in a transceiver module. The transmitter 415 may utilize a single antenna or a set of antennas.

The communication manager 420, the receiver 410, the transmitter 415, or various combinations thereof or various components thereof, may be an example of a means for performing various aspects of cell selection techniques for dual-connectivity operation as described herein. The communication manager 420, or its sub-components, may be implemented in hardware (e.g., in communications management circuitry), code (e.g., software or firmware) executed by a processor, or any combination thereof. If implemented in code executed by a processor, the functions of the communication manager 420, or its sub-components may be executed by a general-purpose processor, a digital signal processor (DSP), a central processing unit (CPU), an application-specific integrated circuit (ASIC), a field-programmable gate array (FPGA) or other programmable logic device, discrete gate or transistor logic, discrete hardware components, or any combination thereof designed to perform the functions described in the present disclosure. In some examples, the communication manager 420 may be configured to perform various operations (e.g., receiving, monitoring, transmitting) using or otherwise in cooperation with the receiver 410, the transmitter 415, or both.

The communication manager 420 may support wireless communication in accordance with examples as disclosed herein. For example, the communication manager 420 may be configured to provide or support a means for receiving, at a UE that supports concurrent communications using a first radio access technology and a second radio access technology, a set of indications indicating upper power limits for uplink transmissions over a set of cells that support the first radio access technology. The communication manager 420 may be configured to provide or support a means for selecting a cell of the set of cells based on a selection criteria being satisfied by the cell and an upper power limit for the cell being less than or equal to a threshold. The communication manager 420 may be configured to provide or support a means for transmitting an uplink transmission over the cell in accordance with the upper power limit for the cell.

By including or configuring the communication manager 420 in accordance with examples as described herein, the device 405 may support improved techniques for reserving sufficient power for uplink transmissions over a secondary cell that uses a different radio access technology than a primary cell, increasing a reliability and/or throughput of uplink transmissions over the secondary cell.

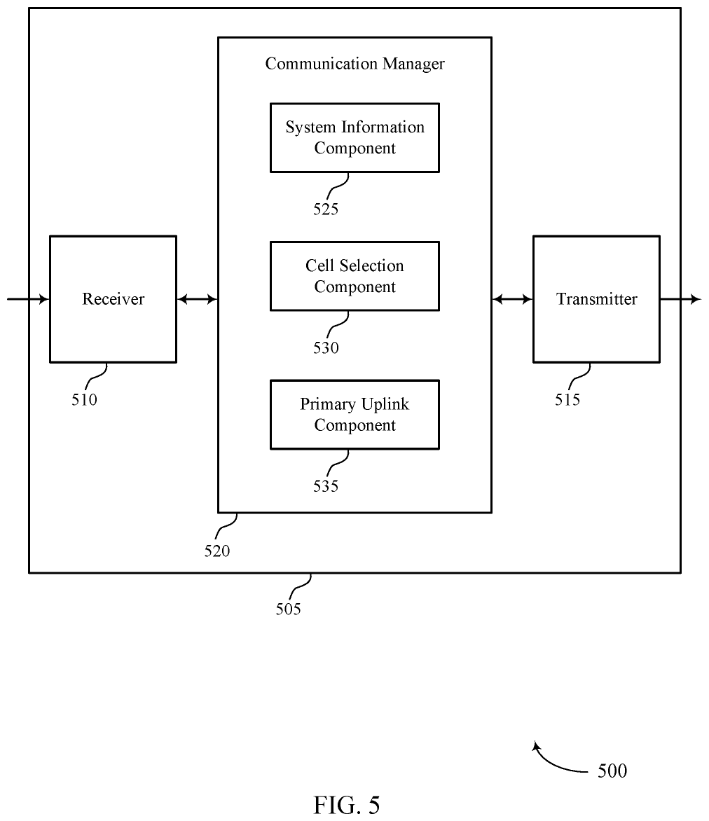

FIG. 5 shows a block diagram 500 of a device 505 that supports cell selection techniques for dual-connectivity operation in accordance with aspects of the present disclosure. The device 505 may be an example of aspects of a device 405 or a UE 115 as described herein. The device 505 may include a receiver 510, a transmitter 515, and a communication manager 520. The device 505 may also include a processor. Each of these components may be in communication with one another (e.g., via one or more buses).

The receiver 510 may provide a means for receiving information such as packets, user data, or control information associated with various information channels (e.g., control channels, data channels, information related to cell selection techniques for dual-connectivity operation). Information may be passed on to other components of the device 505. The receiver 510 may utilize a single antenna or a set of antennas.

The transmitter 515 may provide a means for transmitting signals generated by other components of the device 505. In some examples, the transmitter 515 may be co-located with a receiver 510 in a transceiver module. The transmitter 515 may utilize a single antenna or a set of antennas.

The device 505, or various components thereof, may be an example of means for performing various aspects of cell selection techniques for dual-connectivity operation as described herein. For example, the communication manager 520 may include a system information component 525, a cell selection component 530, a primary uplink component 535, or any combination thereof. The communication manager 520 may be an example of aspects of a communication manager 420 as described herein. In some examples, the communication manager 520, or various components thereof, may be configured to perform various operations (e.g., receiving, monitoring, transmitting) using or otherwise in cooperation with the receiver 510, the transmitter 515, or both.

The communication manager 520 may support wireless communication in accordance with examples as disclosed herein. The system information component 525 may be configured to provide or support a means for receiving, at a UE that supports concurrent communications using a first radio access technology and a second radio access technology, a set of indications indicating upper power limits for uplink transmissions over a set of cells that support the first radio access technology. The cell selection component 530 may be configured to provide or support a means for selecting a cell of the set of cells based on a selection criteria being satisfied by the cell and an upper power limit for the cell being less than or equal to a threshold. The primary uplink component 535 may be configured to provide or support a means for transmitting an uplink transmission over the cell in accordance with the upper power limit for the cell.

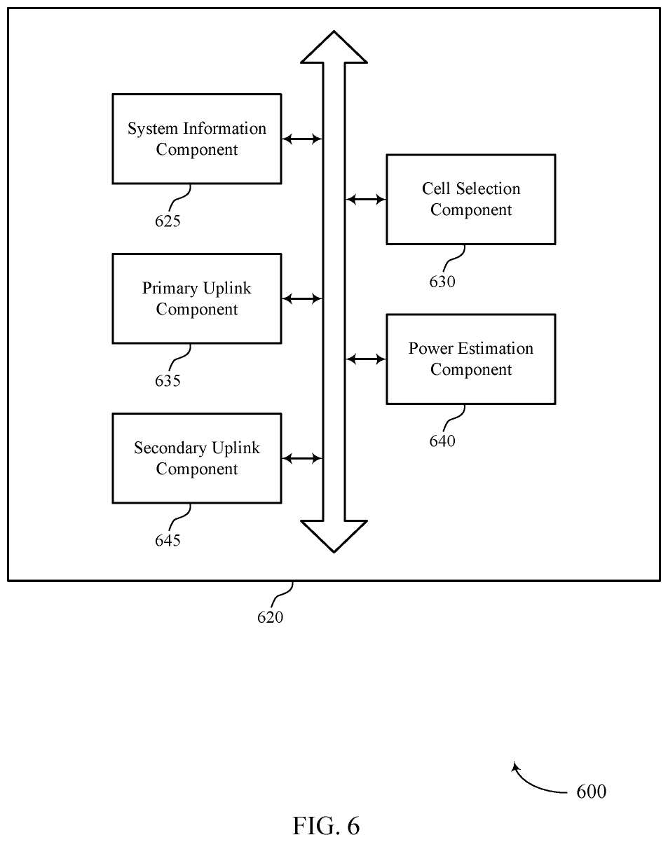

FIG. 6 shows a block diagram 600 of a communication manager 620 that supports cell selection techniques for dual-connectivity operation in accordance with aspects of the present disclosure. The communication manager 620 may be an example of aspects of a communication manager 420 a communication manager 520, or both, as described herein. The communication manager 620, or various components thereof, may be an example of means for performing various aspects of cell selection techniques for dual-connectivity operation as described herein. For example, the communication manager 620 may include a system information component 625, a cell selection component 630, a primary uplink component 635, a power estimation component 640, a secondary uplink component 645, or any combination thereof. Each of these components may communicate, directly or indirectly, with one another (e.g., via one or more buses).

The communication manager 620 may support wireless communication in accordance with examples as disclosed herein. The system information component 625 may be configured to provide or support a means for receiving, at a UE that supports concurrent communications using a first radio access technology and a second radio access technology, a set of indications indicating upper power limits for uplink transmissions over a set of cells that support the first radio access technology. The cell selection component 630 may be configured to provide or support a means for selecting a cell of the set of cells based on a selection criteria being satisfied by the cell and an upper power limit for the cell being less than or equal to a threshold. The primary uplink component 635 may be configured to provide or support a means for transmitting an uplink transmission over the cell in accordance with the upper power limit for the cell.

In some examples, the power estimation component 640 may be configured to provide or support a means for estimating an amount of power to support uplink transmissions over a second cell that supports the second radio access technology. In some examples, the cell selection component 630 may be configured to provide or support a means for determining the threshold based on the amount of power.

In some examples, the secondary uplink component 645 may be configured to provide or support a means for transmitting, concurrently with the uplink transmission over the cell, a second uplink transmission over the second cell in accordance with the second upper power limit.

In some examples, to estimate the amount of power to support uplink transmissions over the second cell, the power estimation component 640 may be configured to provide or support a means for estimating a first amount of power based on identifying a first amount of uplink information for transmission over the second cell. In some examples, to estimate the amount of power to support uplink transmissions over the second cell, the power estimation component 640 may be configured to provide or support a means for estimating a second amount of power based on identifying a second amount of uplink information for transmission over the second cell, where the second amount of power is greater than the first amount of power based on the second amount of uplink information being greater than the first amount of uplink information.

In some examples, to determine the threshold, the cell selection component 630 may be configured to provide or support a means for determining a first threshold based on the first amount of power. In some examples, to determine the threshold, the cell selection component 630 may be configured to provide or support a means for determining a second threshold based on the second amount of power, the second threshold being lower than the first threshold.

In some examples, the cell selection component 630 may be configured to provide or support a means for selecting, prior to selecting the cell of the set of cells, a third cell of the set of cells based on the selection criteria being satisfied, where a third upper power limit for the third cell is greater than the upper power limit for the cell. In some examples, the secondary uplink component 645 may be configured to provide or support a means for determining, based on the third upper power limit for the third cell, a second upper power limit for uplink transmissions over the second cell that supports the second radio access technology. In some examples, the cell selection component 630 may be configured to provide or support a means for selecting, during a reselection procedure, the cell of the set of cells having the upper power limit that is less than the third upper power limit based on the estimated amount of power for supporting uplink transmissions over the second cell exceeding the second upper power limit.

In some examples, the secondary uplink component 645 may be configured to provide or support a means for determining, based on the upper power limit for the cell, a fourth upper power limit for uplink transmissions over the second cell that supports the second radio access technology, where the estimated amount of power for supporting uplink transmissions over the second cell is less than or equal to the fourth upper power limit.

In some examples, the cell selection component 630 may be configured to provide or support a means for a first signal quality for the cell is less than a second signal quality for the second cell.

In some examples, the cell selection component 630 may be configured to provide or support a means for the cell is including in a primary cell group and the second cell is included in a secondary cell group.

In some examples, the cell selection component 630 may be configured to provide or support a means for receiving, from a base station, an indication of the threshold based on supporting concurrent communications using the first radio access technology and the second radio access technology.

In some examples, to select the cell, the cell selection component 630 may be configured to provide or support a means for selecting the cell based on determining that the upper power limit for the cell is the lowest of a set of upper power limits for the set of cells.

In some examples, the cell selection component 630 may be configured to provide or support a means for storing an indication of a subset of the set of cells having upper power limits that are below the threshold, the subset of the set of cells including the cell. In some examples, the cell selection component 630 may be configured to provide or support a means for identifying the cell is included in the subset of the set of cells based on the indication, where the cell is selected based on the identifying.

In some examples, the secondary uplink component 645 may be configured to provide or support a means for activating a second cell that supports the second radio access technology. In some examples, the cell selection component 630 may be configured to provide or support a means for modifying a procedure for selecting cells to be based on the threshold. In some examples, the cell selection component 630 may be configured to provide or support a means for determining a second amount of power available for uplink transmissions over the second cell based at least in part on the upper power limit for the cell; and modifying, based at least in part on the amount of power exceeding the second amount of power by a third amount, a procedure for selecting cells to be based at least in part on the threshold.

In some examples, the system information component 625 may be configured to provide or support a means for receiving a set of system information messages including the set of indications, where the set of system information messages include one or more of a SIB 1 message, a SIB 3 message, a SIB 5 message, or a SIB 6 messages.

In some examples, a second upper power limit for uplink transmissions over a second set of cells that supporting the second radio access technology is based on the upper power limit for the cell.

In some examples, the second upper power limit decreases when the upper power limit for uplink transmissions over the set of cells that support the first radio access technology increases, and where the second upper power limit increases when the upper power limit for uplink transmissions over the set of cells decreases.

In some examples, the UE is operating in an idle mode and cells that supports the second radio access technology are absent for selection by the UE.

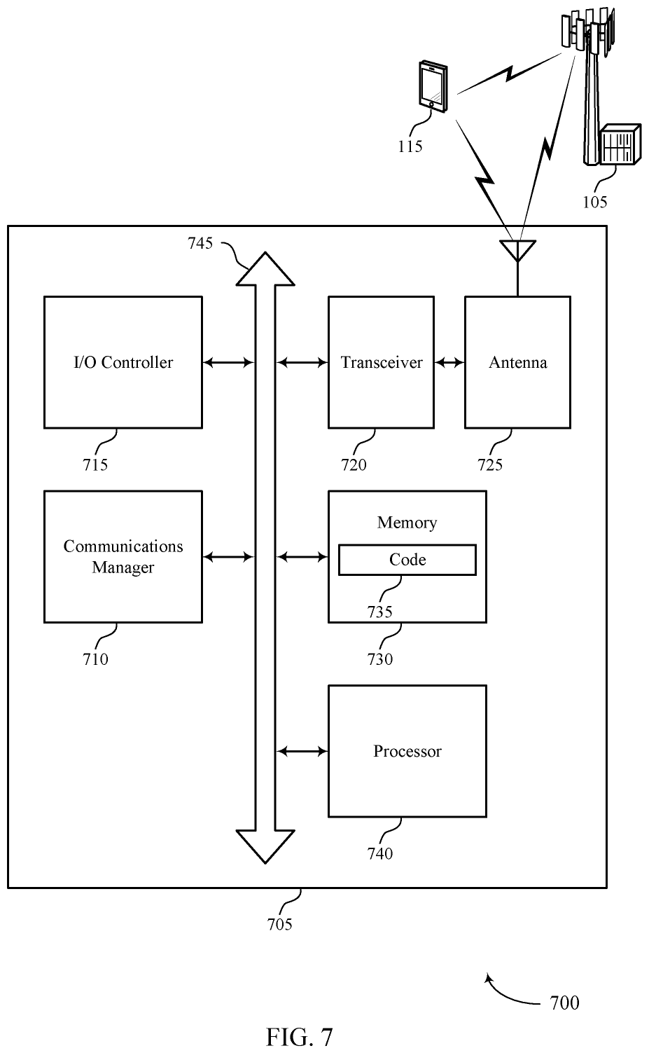

FIG. 7 shows a diagram of a system 700 including a device 705 that supports cell selection techniques for dual-connectivity operation in accordance with aspects of the present disclosure. The device 705 may be an example of or include the components of device 405, device 505, or a UE 115 as described herein. The device 705 may communicate wirelessly with one or more base stations 105, UEs 115, or any combination thereof. The device 705 may include components for bi-directional voice and data communications including components for transmitting and receiving communications, including a communication manager 710, a I/O controller 715, a transceiver 720, an antenna 725, a memory 730, a code 735, and a processor 740. These components may be in electronic communication or otherwise coupled (e.g., operatively, communicatively, functionally, electronically, electrically) via one or more buses (e.g., bus 745).

The I/O controller 715 may manage input and output signals for device 705. The I/O controller 715 may also manage peripherals not integrated into device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with device 705 via the I/O controller 715 or via hardware components controlled by the I/O controller 715.

In some cases, the device 705 may include a single antenna 725. However, in some cases the device may have more than one antenna 725, which may be capable of concurrently transmitting or receiving multiple wireless transmissions. The transceiver 720 may communicate bi-directionally, via the one or more antennas 725, wired, or wireless links as described herein. For example, the transceiver 720 may represent a wireless transceiver and may communicate bi-directionally with another wireless transceiver. The transceiver 720 may also include a modem to modulate the packets and provide the modulated packets to one or more antennas 725 for transmission, and to demodulate packets received from the one or more antennas 725. The transceiver 720, or the transceiver 720 and one or more antennas 725, may be an example of a transmitter 415, a transmitter 515, a receiver 410, a receiver 510, or any combination thereof or component thereof, as described herein.

The memory 730 may include random-access memory (RAM) and read-only memory (ROM). The memory 730 may store computer-readable, computer-executable code 730 including instructions that, when executed by the processor 740, cause the device 705 to perform various functions described herein. The code 735 may be stored in a non-transitory computer-readable medium such as system memory or other type of memory. In some cases, the code 735 may not be directly executable by the processor 740 but may cause a computer (e.g., when compiled and executed) to perform functions described herein. In some cases, the memory 730 may contain, among other things, a basic input/output system (BIOS) which may control basic hardware or software operation such as the interaction with peripheral components or devices.

The processor 740 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting cell selection techniques for dual-connectivity operation).

The communication manager 710 may support wireless communication in accordance with examples as disclosed herein. For example, the communication manager 710 may be configured to provide or support a means for receiving, at a UE that supports concurrent communications using a first radio access technology and a second radio access technology, a set of indications indicating upper power limits for uplink transmissions over a set of cells that support the first radio access technology. The communication manager 710 may be configured to provide or support a means for selecting a cell of the set of cells based on a selection criteria being satisfied by the cell and an upper power limit for the cell being less than or equal to a threshold. The communication manager 710 may be configured to provide or support a means for transmitting an uplink transmission over the cell in accordance with the upper power limit for the cell.

In some examples, the communication manager 710 may be configured to perform various operations (e.g., receiving, monitoring, transmitting) using or otherwise in cooperation with the transceiver 720, the one or more antennas 725, or any combination thereof. Although the communication manager 710 is illustrated as a separate component, in some examples, one or more functions described with reference to the communication manager 710 may be supported by or performed by the processor 740, the memory 730, the code 735, or any combination thereof. For example, the code 735 may include instructions executable by the processor 740 to cause the device 705 to perform various aspects of cell selection techniques for dual-connectivity operation as described herein, or the processor 740 and the memory 730 may be otherwise configured to perform or support such operations.

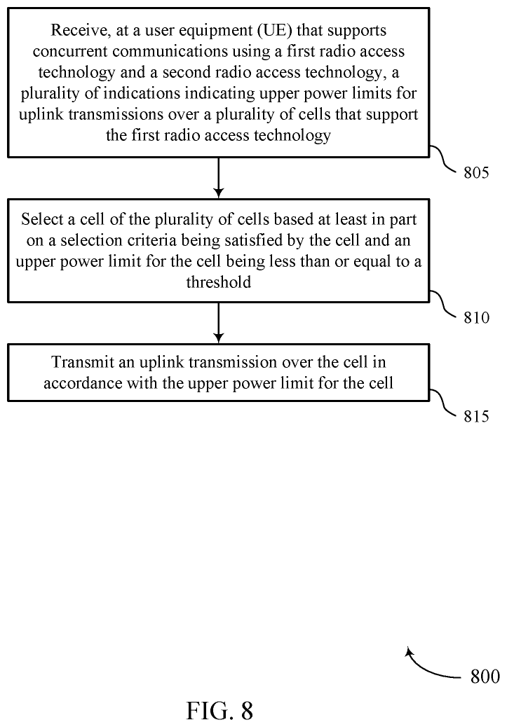

FIG. 8 shows a flowchart illustrating a method 800 for cell selection techniques for dual-connectivity operation in accordance with aspects of the present disclosure. The operations of method 800 may be implemented by a UE or its components as described herein. For example, the operations of method 800 may be performed by a UE 115 as described with reference to FIGS. 1 through 7. In some examples, a UE may execute a set of instructions to control the functional elements of the device to perform the described functions. Additionally, or alternatively, the UE may perform aspects of the described functions using special-purpose hardware.

At 805, the method may include receiving, at a user equipment (UE) that supports concurrent communications using a first radio access technology and a second radio access technology, a plurality of indications indicating upper power limits for uplink transmissions over a plurality of cells that support the first radio access technology. The operations of 805 may be performed according to the methods described herein. In some examples, aspects of the operations of 805 may be performed by a system information component 625 as described with reference to FIG. 6.

At 810, the method may include selecting a cell of the plurality of cells based at least in part on a selection criteria being satisfied by the cell and an upper power limit for the cell being less than or equal to a threshold. The operations of 810 may be performed according to the methods described herein. In some examples, aspects of the operations of 810 may be performed by a cell selection component 630 as described with reference to FIG. 6.

At 815, the method may include transmitting an uplink transmission over the cell in accordance with the upper power limit for the cell. The operations of 815 may be performed according to the methods described herein. In some examples, aspects of the operations of 815 may be performed by a primary uplink component 635 as described with reference to FIG. 6.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving, at a user equipment (UE) that supports concurrent communications using a first radio access technology and a second radio access technology, a plurality of indications indicating upper power limits for uplink transmissions over a plurality of cells that support the first radio access technology;
selecting a cell of the plurality of cells based at least in part on a selection criteria being satisfied by the cell and an upper power limit for the cell being less than or equal to a threshold; and
transmitting an uplink transmission over the cell in accordance with the upper power limit for the cell.

2. The method of claim 1, further comprising:
estimating an amount of power to support uplink transmissions over a second cell that supports the second radio access technology; and
determining the threshold based at least in part on the amount of power.

3. The method of claim 2, wherein a second upper power limit for the second cell is based at least in part on the threshold and the upper power limit for the cell, the method further comprising:
transmitting, concurrently with the uplink transmission over the cell, a second uplink transmission over the second cell in accordance with the second upper power limit.

4. The method of claim 2, wherein estimating the amount of power to support uplink transmissions over the second cell comprises:
estimating a first amount of power based at least in part on identifying a first amount of uplink information for transmission over the second cell; or
estimating a second amount of power based at least in part on identifying a second amount of uplink information for transmission over the second cell, wherein the second amount of power is greater than the first amount of power based at least in part on the second amount of uplink information being greater than the first amount of uplink information.

5. The method of claim 4, wherein determining the threshold comprises:
determining a first threshold based at least in part on the first amount of power; or
determining a second threshold based at least in part on the second amount of power, the second threshold being lower than the first threshold.

6. The method of claim 2, further comprising:
selecting, prior to selecting the cell of the plurality of cells, a third cell of the plurality of cells based at least in part on the selection criteria being satisfied, wherein a third upper power limit for the third cell is greater than the upper power limit for the cell;
determining, based at least in part on the third upper power limit for the third cell, a second upper power limit for uplink transmissions over the second cell that supports the second radio access technology; and
selecting, during a reselection procedure, the cell of the plurality of cells having the upper power limit that is less than the third upper power limit based at least in part on the estimated amount of power for supporting uplink transmissions over the second cell exceeding the second upper power limit.

7. The method of claim 6, further comprising:
determining, based at least in part on the upper power limit for the cell, a fourth upper power limit for uplink transmissions over the second cell that supports the second radio access technology, wherein the estimated amount of power for supporting uplink transmissions over the second cell is less than or equal to the fourth upper power limit.

8. The method of claim 6, wherein a first signal quality for the cell is less than a second signal quality for the second cell.

9. The method of claim 2, wherein the cell is included in a primary cell group and the second cell is included in a secondary cell group.

10. The method of claim 2, further comprising:
determining a second amount of power available for uplink transmissions over the second cell based at least in part on the upper power limit for the cell; and
modifying, based at least in part on the amount of power exceeding the second amount of power by a third amount, a procedure for selecting cells to be based at least in part on the threshold.

11. The method of claim 1, further comprising:
receiving, from a base station, an indication of the threshold based at least in part on supporting concurrent communications using the first radio access technology and the second radio access technology.

12. The method of claim 1, wherein selecting the cell comprises:
selecting the cell based at least in part on determining that the upper power limit for the cell is the lowest of a plurality of upper power limits for the plurality of cells.

13. The method of claim 1, further comprising:
storing an indication of a subset of the plurality of cells having upper power limits that are below the threshold, the subset of the plurality of cells comprising the cell; and
identifying the cell is included in the subset of the plurality of cells based at least in part on the indication, wherein the cell is selected based at least in part on the identifying.

14. The method of claim 1, further comprising:
activating a second cell that supports the second radio access technology; and
modifying, based at least in part on activating the second cell, a procedure for selecting cells to be based at least in part on the threshold.

15. The method of claim 1, further comprising:
receiving a plurality of system information messages comprising the plurality of indications, wherein the plurality of system information messages comprise one or more of a system information block (SIB) 1 message, a SIB 3 message, a SIB 5 message, or a SIB 6 messages.

16. The method of claim 1, wherein a second upper power limit for uplink transmissions over a second plurality of cells that support the second radio access technology is based at least in part on the upper power limit for the cell.

17. The method of claim 16, wherein the second upper power limit decreases when the upper power limit for uplink transmissions over the plurality of cells that support the first radio access technology increases, and wherein the second upper power limit increases when the upper power limit for uplink transmissions over the plurality of cells decreases.

18. The method of claim 1, wherein the UE is operating in an idle mode and cells that supports the second radio access technology are absent for selection by the UE.

19. An apparatus for wireless communication at a user equipment (UE), comprising:
a processor;
memory coupled with the processor; and
instructions stored in the memory and executable by the processor to cause the apparatus to:
receive, at a user equipment (UE) that supports concurrent communications using a first radio access technology and a second radio access technology, a plurality of indications indicating upper power limits for uplink transmissions over a plurality of cells that support the first radio access technology;
select a cell of the plurality of cells based at least in part on a selection criteria being satisfied by the cell and an upper power limit for the cell being less than or equal to a threshold; and
transmit an uplink transmission over the cell in accordance with the upper power limit for the cell.

20. The apparatus of claim 19, wherein the processor is further executable to cause the apparatus to:
estimate an amount of power to support uplink transmissions over a second cell that supports the second radio access technology; and
determine the threshold based at least in part on the amount of power.

21. The apparatus of claim 20, wherein a second upper power limit for the second cell is based at least in part on the threshold and the upper power limit for the cell, and wherein the processor is further executable to cause the apparatus to:
transmit, concurrently with the uplink transmission over the cell, a second uplink transmission over the second cell in accordance with the second upper power limit.

22. The apparatus of claim 20, wherein the instructions for estimating the amount of power to support uplink transmissions over the second cell are further executable by the processor to cause the apparatus to:
estimate a first amount of power based at least in part on identifying a first amount of uplink information for transmission over the second cell; or
estimate a second amount of power based at least in part on identifying a second amount of uplink information for transmission over the second cell, wherein the second amount of power is greater than the first amount of power based at least in part on the second amount of uplink information being greater than the first amount of uplink information.

23. The apparatus of claim 20, wherein the processor is further executable to cause the apparatus to:
select, prior to selecting the cell of the plurality of cells, a third cell of the plurality of cells based at least in part on the selection criteria being satisfied, wherein a third upper power limit for the third cell is greater than the upper power limit for the cell;
determine, based at least in part on the third upper power limit for the third cell, a second upper power limit for uplink transmissions over the second cell that supports the second radio access technology; and
select, during a reselection procedure, the cell of the plurality of cells having the upper power limit that is less than the third upper power limit based at least in part on the estimated amount of power for supporting uplink transmissions over the second cell exceeding the second upper power limit.

24. The apparatus of claim 19, wherein the processor is further executable to cause the apparatus to:
store an indication of a subset of the plurality of cells having upper power limits that are below the threshold, the subset of the plurality of cells comprising the cell; and
identify the cell is included in the subset of the plurality of cells based at least in part on the indication, wherein the cell is selected based at least in part on the identifying.

25. The apparatus of claim 19, wherein the processor is further executable to cause the apparatus to:
activate a second cell that supports the second radio access technology; and
modify a procedure for selecting cells to be based at least in part on the threshold based at least in part on activating the second cell.

26. An apparatus for wireless communication at a user equipment (UE), comprising:
means for receiving, at a user equipment (UE) that supports concurrent communications using a first radio access technology and a second radio access technology, a plurality of indications indicating upper power limits for uplink transmissions over a plurality of cells that support the first radio access technology;
means for selecting a cell of the plurality of cells based at least in part on a selection criteria being satisfied by the cell and an upper power limit for the cell being less than or equal to a threshold; and
means for transmitting an uplink transmission over the cell in accordance with the upper power limit for the cell.

27. The apparatus of claim 26, further comprising:
means for estimating an amount of power to support uplink transmissions over a second cell that supports the second radio access technology; and
means for determining the threshold based at least in part on the amount of power.

28. The apparatus of claim 27, wherein a second upper power limit for the second cell is based at least in part on the threshold and the upper power limit for the cell, the apparatus further comprising:
means for transmitting, concurrently with the uplink transmission over the cell, a second uplink transmission over the second cell in accordance with the second upper power limit.

29. The apparatus of claim 26, further comprising:
means for storing an indication of a subset of the plurality of cells having upper power limits that are below the threshold, the subset of the plurality of cells comprising the cell; and
means for identifying the cell is included in the subset of the plurality of cells based at least in part on the indication, wherein the cell is selected based at least in part on the identifying.

30. A non-transitory computer-readable medium storing code for wireless communication at a user equipment (UE), the code comprising instructions executable by a processor to:
receive, at a user equipment (UE) that supports concurrent communications using a first radio access technology and a second radio access technology, a plurality of indications indicating upper power limits for uplink transmissions over a plurality of cells that support the first radio access technology;
select a cell of the plurality of cells based at least in part on a selection criteria being satisfied by the cell and an upper power limit for the cell being less than or equal to a threshold; and
transmit an uplink transmission over the cell in accordance with the upper power limit for the cell.
